(19) United States
(12) Patent Application Publication
(10) Pub. No.: US 2012/0250148 A1
(43) Pub. Date: Oct. 4, 2012

(54) ARRANGEMENT FOR EQUALIZING BINOCULAR VISUAL FIELDS

(75) Inventors: Cornelia Bendlin, Goettingen (DE); Ingo Fahlbusch, Goettingen (DE); Werner Kleinschmidt, Adelebsen (DE)

(73) Assignee: CARL ZEISS MICROIMAGING GMBH, Jena (DE)

(21) Appl. No.: 13/514,038

(22) PCT Filed: Aug. 23, 2010
(86) PCT No.: PCT/EP2010/062233

§ 371 Date: Jun. 5, 2012

(30) Foreign Application Priority Data
Dec. 8, 2009 (DE) 102009057530.8

(51) Int. Cl. G02B 21/20

(52) U.S. Cl. 359/375

(57) ABSTRACT

An arrangement for equalizing binocular visual fields for microscopes and other optical instruments, with an eyepiece arranged in each beam path, and with diaphragms serving the purpose of visual field adjustment. The diaphragms are fixed or movable in or in immediate proximity to an intermediate image plane in the optical output to the left eye and/or to the right eye. One diaphragm is arranged eccentrically or concentrically in the installation space of at least one eyepiece or in at least one eyepiece support of the corresponding optical instrument provided therefor. Adjusters are present for positioning and/or adjusting the diaphragms.

### PRIORITY CLAIM

The present application is a National Phase entry of PCT Application No. PCT/EP2010/062233, filed Aug. 23, 2010, which claims priority from German Application Number 102009057530.8, filed Dec. 8, 2009, the disclosures of which are hereby incorporated by reference herein in their entirety.

### FIELD OF THE INVENTION

The invention relates to an arrangement for equalizing binocular fields of view for microscopes and other optical instruments with an eyepiece arranged in each beam path and with diaphragms serving the purpose of adjusting the fields of view.

### BACKGROUND OF THE INVENTION

What is known are optical instruments as, for example, microscopes, with a binocular viewing tube, in which the image centers and, thus, the edges of the field of views, do not exactly register when observed binocularly. Small deviations within specified tolerances are quite common.

As it is desirable for optical instruments to have a field of view as large as possible, users also utilize image information found in the margin of the field of view. In this, however, different field-of-view edges visible to the left and the right eye can be rather disturbing. When observing regular patterns, for example, one may have a three-dimensional image impression. As the images seen with both eyes are normally processed into one common image by the brain, deviations between the left and right eyes may lead to headache and visual disturbance. Minimizing the problem by narrowing down the tolerances of the optical instruments in order to achieve the least possible deviations between the, leads to instruments that are rather laborious to make and, thus, expensive, while even they cannot eliminate the problem completely.

### SUMMARY OF THE INVENTION

The invention solves many of the problems of designing an arrangement for equalizing binocular fields of view to the effect that a complete congruence of the image impressions of the left and the right eye up to the edges of the fields of view is made possible in a relatively simple way and, thus, at affordable cost.

According to the invention, this problem is solved with an arrangement of the kind described above for equalizing binocular fields of view in which arrangement the diaphragms are mounted, either immovably or movably, in the optical output to the left and/or right eye in the intermediate image plane or in its immediate proximity, and a diaphragm is arranged either centered or eccentrically within the volume of at least one eyepiece or in at least one eyepiece sleeve, provided therefore, of the respective optical instrument, and means are provided for positioning and/or adjusting the diaphragms.

Thus, it is also possible for the entire eyepiece with a non-movably mounted eccentric diaphragm to be rotated in an aperture provided therefore, e.g. the aperture of a microscope's viewing tube. Should the intermediate image not be situated within the volume of the eyepiece, a movable diaphragm designed according to the invention can, with known means, be inserted in an appropriate place in the eyepiece sleeve of the left and/or right optical output. Below, the latter version is meant to be understood as an alternative whenever a diaphragm in an eyepiece or in the volume of an eyepiece is described.

If it is certain, in a particular application, that there is always a certain range between the minimum and the maximum offset occurring between the fields of view in the left and the right viewing channel, a rotatable diaphragm mounted eccentrically in one viewing channel is sufficient, whereas a fixed diaphragm mounted concentrically in the other viewing channel defines the reference image for the exit provided with the rotatable diaphragm. The minimum offset must not equal zero in this case.

Typically, the location of the intermediate image or of the diaphragm is situated within the volume of the eyepieces. To enable an adjustable diaphragm in, or in the immediate proximity of, the intermediate image plane to be movable, a sufficiently large-diameter optical aperture is required. As a rule, however, already for optical reasons, there is only a very small range of movement that can be reasonably used for an adjustable diaphragm, since a major offset of the pencil of rays coming from the same object point through the left and the right eyepiece, due to imperfections in their optics, may result in visibly different optical aberrations.

Within a relatively small range, an image center deviating from that of the reference image can be compensated already by rotating the eyepiece in the eyepiece sleeve of the optical instrument used, e.g., of a microscope's viewing tube, if a circular diaphragm is mounted eccentrically to the eyepiece axis.

However, this will not suffice to compensate every feasible offset relative to the reference image.

In order to compensate every offset occurring within a specified tolerance, one either has to use eccentrically mounted diaphragms according to the invention in both eyepieces, with both diaphragms capable of being rotated with the respective eyepiece for equalizing the fields of view, or, according to the invention, an extra, suitably adjustable offset of the eccentrically mounted diaphragm must be provided in the eyepiece. By suitable adjusting means, any distance can be set between the center of the diaphragm and the center of the eyepiece.

In principle, this could also be achieved with centrically preset diaphragm, provided it can be shifted accordingly within the intermediate image plane. In this case, however,—with the sole exception of the right and left viewing channel being in register by chance—a more difficult adjustment of the diaphragm by shifting would be necessary, whereas, with a diaphragm mounted eccentrically from the start, an image offset relative to the reference image can often be handled already by a simple rotation of the eyepiece in the eyepiece sleeve of the binocular optical instrument, e.g., a microscope's viewing tube.

In a favorable embodiment, a diaphragm is eccentrically mounted within the volumes of each of the two eyepieces. This permits the fields of view to be brought into register by rotating the eyepieces even if the centers of the fields of view deviate within a greater range. This also includes the case of the left and right viewing channels being in register.

Favorably, for the purpose of adjusting the diaphragms, means of adjustment that can be arrested and act on the diaphragms are mounted in the eyepieces themselves; such means may be designed, e.g., as setscrews. The use of other known adjusting means is feasible as well.

To accomplish an equalization of the fields of view both for the case that there is no offset between the eyepiece centers and for the case of an offset within a specified tolerance, it is sufficient to use only one eyepiece with a horizontally shiftable diaphragm, whereas the other eyepiece contains an eccentric diaphragm that is rotatable with the eyepiece, or even a centric diaphragm. In the latter case, however, only a smaller maximum offset between the eyepiece centers could be compensated, and in case a diaphragm is adjustable only along one spatial direction, the diaphragm must be rotatable in addition.

For the purpose of shifting the diaphragm in the eyepiece, possible embodiment versions provide the arrangement of either two adjusting means spaced at 180 degrees or three such means spaced at 120 degrees, these adjusting means being situated within the range of the intermediate image plane and mounted into the wall of the respective eyepiece volume in such a way that they are accessible from the outside of the eyepiece but, wherever possible, do not extend out from the surface.

With the adjusting means, the diaphragm provided inside the eyepiece can be shifted in such a way that it can be brought into any desired position and fixed there by “clamping”, e.g. by slightly tightening the setscrews.

This embodiment version of diaphragm adjustment is disadvantageous compared to changing the diaphragm position by a simple rotation of the eyepiece unless the adjustment can be carried out under observation. This can be remedied if the setscrews can be accessed also with the eyepieces fitted into the optical instrument. Realizing this seems to be quite useful and feasible with many optical instruments, reasonable technical effort and cost provided.

### BRIEF DESCRIPTION OF THE DRAWINGS

Below, the binocular viewing tube according to the invention is explained in greater detail with reference to exemplary embodiments employed on a microscope's viewing tube.

Of the accompanying drawings,

FIG. 1 is a schematic diagram of the diaphragm arrangement in the eyepieces according to prior art,

FIG. 2 is a schematic diagram of fields of view not in register, with a diaphragm arrangement in the eyepieces according to prior art,

FIG. 3 is a schematic diagram of the invented diaphragm arrangement in the eyepieces with one eccentrically mounted diaphragm,

FIG. 4 is a schematic diagram of fields of view not in register before equalization (view A) and of the accomplished equalization of the fields of view (view B) according to FIG. 3, for the case that there is, as in FIG. 2, a minimum offset between the eyepiece centers,

FIG. 5 is a schematic diagram of the invented diaphragm arrangement in the eyepieces, with an eccentrically mounted diaphragm in each eyepiece,

FIG. 6 is a schematic diagram of fields of view not in register before equalization (view C) and of the accomplished equalization of the fields of view (view D) according to FIG. 5 for the special case that there is no offset between the eyepiece centers,

FIG. 7 is a schematic diagram after equalization of the fields of view accomplished according to the invention, with large offset,

FIG. 8 is a design diagram of a horizontally adjustable diaphragm in the volume of an eyepiece.

### DETAILED DESCRIPTION OF THE DRAWINGS

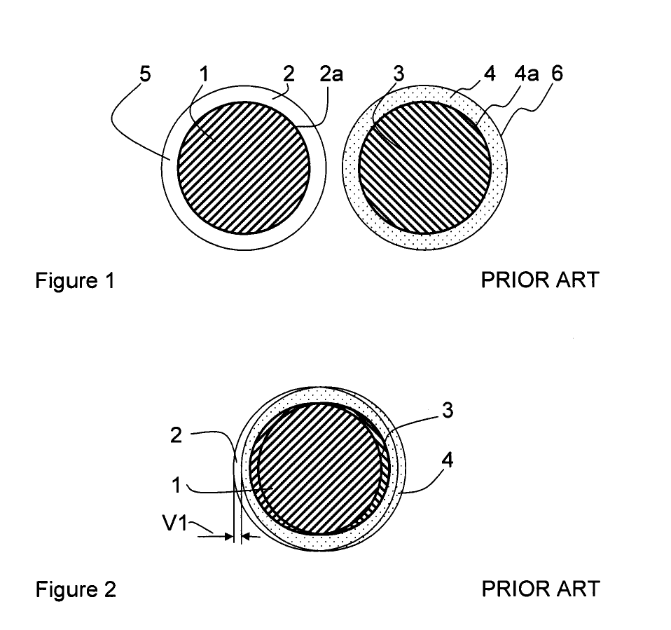

FIG. 1 shows the embodiment, as known in the prior art, with a diaphragm 2, which has a diaphragm edge 2a and is mounted concentrically in the volume of an eyepiece or in an eyepiece sleeve 5 for the viewing channel of the left eye, and a diaphragm 4, which has a diaphragm edge 4a and is mounted, also concentrically, in the volume of another eyepiece or in the eyepiece sleeve 6 for the viewing channel of the right eye. As the eyepiece sleeve is used to guide the eyepiece, the rim of the eyepiece contacting the inside of the sleeve is not shown separately.

Usually, as e.g. in a microscope's viewing tube, the left and right viewing channels are slightly offset from one another within the scope of the manufacturing tolerances, so that, with concentrically mounted diaphragms, the fields of view 1 and 3 as seen by the left and the right eye will not register. The offset V1 between them is shown in FIG. 2.

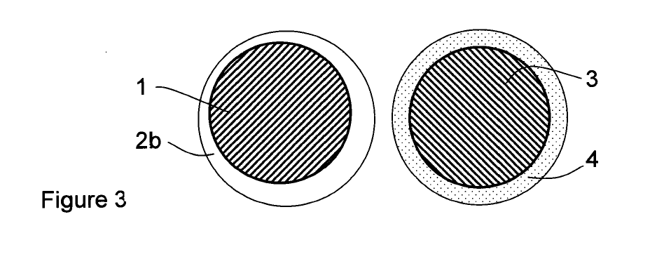

FIG. 3 schematically shows the invented binocular viewing tube with the fields of view 1 and 3, e.g. in case of a microscope's viewing tube, with one diaphragm 2b eccentrically arranged in the eyepiece for the left eye, whereas the diaphragm 4 in the eyepiece for the right eye remains in the concentric position. Because of the eccentric arrangement of the diaphragm 2b in the eyepiece it is possible, for a certain range of offset between the left and the right viewing channel, to equalize the field of view 1 with the field of view 3 by rotating the eyepiece intended for the left eye.

Related to this, FIG. 4 shows, in view A, fields of view 1 and 3, which are not in register under binocular observation before the rotation of the eyepiece, and, in view B, fields of view 1 and 3 in register (3 covered by 1) after bringing the diaphragms into register with an offset V2 of the diaphragm edges in this position; this offset V2 can be equal to the offset V1 of FIG. 2.

However, in certain cases it is not possible to equalize the binocular fields of view by the combination of an eyepiece with concentric diaphragm and an eyepiece with fixed eccentric diaphragm, e.g., if (in exceptional cases) there is no deviation between the left and the right viewing channel.

In this case, the invention provides for an adjusting facility by which the diaphragm can be shifted in the desired direction in the volume of the eyepiece itself.

The advantage of using only one eyepiece with a fixed eccentric or an adjustable diaphragm is that the other eyepiece featuring a concentrically mounted diaphragm can be provided with, e.g., an eyepiece reticle, which could be rotated with the eyepiece through any angle without effecting any change of the specimen area visible in the field of view.

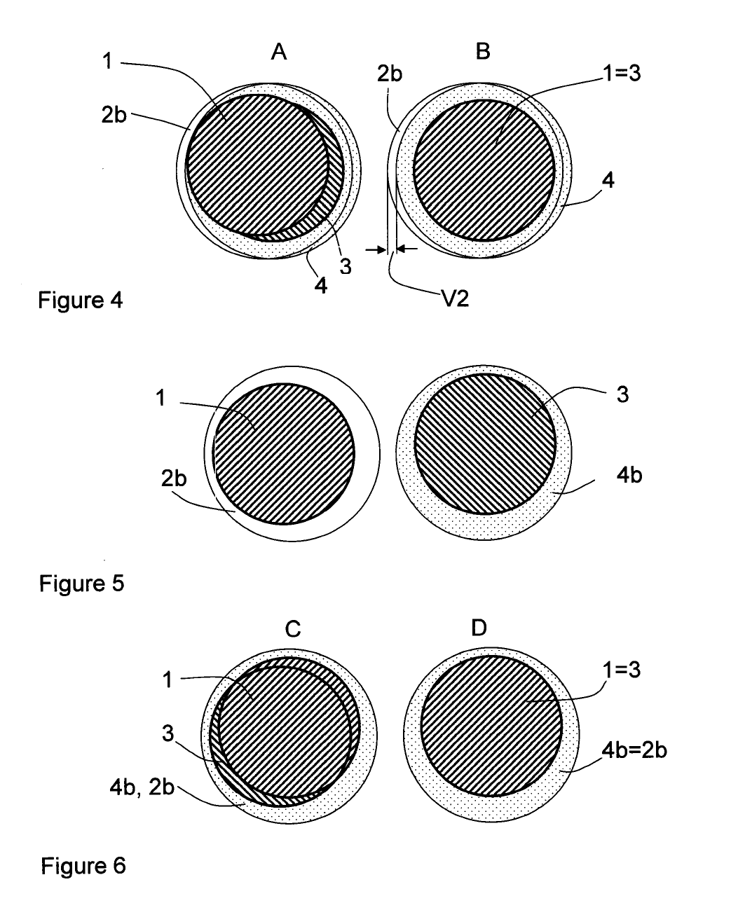

Alternatively, two eyepieces with non-movable eccentric diaphragms 2b and 4b can be used (FIG. 5), which makes it possible to equalize not only such left and right fields of view (1 and 3) that are (by chance) equal because the binocular instrument has no offset between the centers of the eyepiece sleeves.

In view C of FIG. 6, this is shown before the rotation of both eyepieces, whereas view D of FIG. 6 shows the fields of view 1 and 3 in register after equalization by means of the diaphragms.

With this embodiment as invented it is possible to equalize even more extreme cases with greater deviations between the left and the right viewing channel than those that can be equalized if only one eyepiece with a non-movable eccentric diaphragm is used.

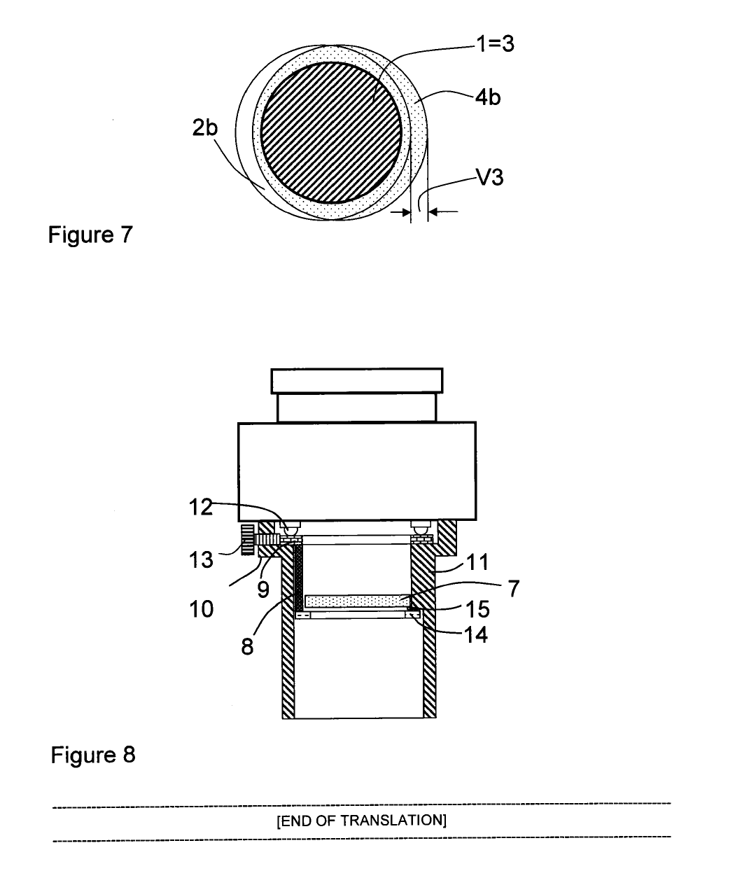

In this connection, FIG. 7 schematically shows a successful equalization in case of a major difference between the left and the right viewing channel, by the rotation of both eyepieces.

The capability of compensating a greater offset V3 can be seen by the maximum distance compared to the offset V2 shown in FIG. 4 (B).

In this embodiment, however, the additional use of a reticle or the like in one eyepiece is somewhat problematic, since the rotation of the reticle, e.g. for the purpose of aligning it with some detail of the microscopy specimen, would also effect a rotation of the eyepiece together with the diaphragm unless auxiliary design features were provided. This would cause new deviations between the left and the right field of view, which could not be compensated in all cases as before.

A solution of this problem could be, e.g., the provision of a separately rotatable reticle.

Another possible solution is shown schematically in FIG. 8 as an exemplary technical implementation of an adjustable diaphragm 14. Here, the diaphragm 14 is designed as a ring provided in the usual diaphragm position in the eyepiece below a reticle seat 15. A reticle 7, held by a reticle seat 15, can be fitted as an option. The solution shown here for an adjustable diaphragm 14 does not concern the well-known adjusting mechanisms for such a reticle 7; therefore, details of the adjustment of the reticle are not described here.

The principle of diaphragm adjustment explained below applies to eyepieces with and without the possibility of inserting a reticle 7. Here, the ring 14 (diaphragm) is preferably provided with drilled holes, in which pins 8 are inserted having a length permitting them to engage with a second ring 9, which serves as an adjusting ring, is located in an eyepiece guiding sleeve 11 above an eyepiece locating surface 10, and is guided axially without play by at least one spring plate 12 or the like. This second (upper) ring 9 can then be moved by means of adjusting screws 13. Preferably, two adjusting screws 13 are used, spaced by an angle of 120°. In addition, a resilient element (not shown in the drawing), preferably spaced from the adjusting screws 13 by 120° again, is required to enable the adjustable diaphragm 14 to be movable in any desired direction.

Other solutions are possible as well, e.g., with different angular spacings or with a different number of adjusting screws 13 and/or resilient elements. In principle, diaphragm adjustment could be done without resilient elements, provided that there are a sufficient number of adjusting screws 13 which, by successive loosening and tightening, finally keep the diaphragm 14 in the desired position.

As this solution allows the diaphragm 14 to be moved to every desired direction without the need of additionally rotating the eyepiece for equalizing the fields of view, insertion of the reticle 7 into makes it possible to align this reticle, e.g. along a certain structure in the field of view by rotating the entire eyepiece and subsequently to equalize the fields of view again by another adjustment of the diaphragm 14 without changing the alignment of the reticle 7.

If, by contrast, the user does not attach importance to any capability of diaphragm adjustment that is independent of a rotation of the eyepiece, e.g. because no reticle 7 is used at all, he has the choice of bringing about an equalization of the fields of view by a combination of a diaphragm 14 that is movable in one direction only and a rotation of the eyepiece. For this, already one adjusting screw 13 and one resilient element, preferably spaced from each other by an angle of 180°, would suffice. The same adjusting operation would also be possible with two adjusting screws 13 (without resilient element), or with the two adjusting components selected being spaced by an angle different from 180°.

For the possible ways of diaphragm adjustment described, the maximum total number of all adjusting screws 13 and resilient elements used is not necessarily limited to three; with a greater number of these components, though, the complexity of the design would be greater without any increase in benefit. In all cases, however, the diaphragm 14 can be adjusted and the fields of view for both channels can be made to register.

### LIST OF REFERENCE NUMBERS

1,3 fields of view

2,4 concentric diaphragms

2a,4a diaphragm edges

2b,4b eccentric diaphragms

5,6 eyepiece sleeves

7 reticle

8 (connecting) pins

9 ring

10 eyepiece locating surface

11 eyepiece guiding sleeve

12 spring plate

13 adjusting screw

14 diaphragm

15 reticle seat

V1,V2,V3 offsets

A,B,C,D views

1-11. (canceled)

12. An arrangement for equalizing binocular fields of view for microscopes and other optical instruments with an eyepiece arranged in each of two beam paths, the arrangement comprising:
diaphragms serving the purpose of equalizing the fields of view,
wherein the diaphragms are mounted immovably or movably in, or in immediate proximity of, an intermediate image plane in an optical output to a left and/or a right eye, with at least one diaphragm being eccentrically or concentrically arranged within the volume of at least one eyepiece or in at least one eyepiece sleeve of the microscope or other optical instrument, and
further comprising adjusters for positioning and/or adjusting the diaphragms.

13. The arrangement for equalizing binocular fields of view as claimed in claim 12, wherein one of the diaphragms is a concentrically mounted diaphragm arranged in the eyepiece sleeve or within a volume of one eyepiece and another of the diaphragms is an eccentrically mounted diaphragm arranged in the eyepiece sleeve or within a volume of a second eyepiece.

14. The arrangement for equalizing binocular fields of view as claimed in claim 12, wherein the diaphragms are eccentrically mounted diaphragms arranged in volumes of both eyepieces.

15. The arrangement for equalizing binocular fields of view as claimed in claim 13, further comprising a microscope viewing tube and wherein the at least one eyepiece sleeve is coupled to the microscope viewing tube.

16. The arrangement for equalizing binocular fields of view as claimed in claim 12, wherein one of the diaphragms comprises an eccentrically arranged diaphragm mounted immovably.

17. The arrangement for equalizing binocular fields of view as claimed in claim 12, wherein one of the diaphragms comprises an eccentrically arranged diaphragm mounted adjustably.

18. The arrangement for equalizing binocular fields of view as claimed in claim 12, wherein the diaphragms comprises concentrically arranged diaphragms arranged adjustably.

19. The arrangement for equalizing binocular fields of view as claimed in claim 12 further comprising, for the purpose of adjusting the diaphragms, arrestable adjusters that act on the diaphragms and that are mounted within the volume of the eyepiece or in the eyepiece sleeve.

20. The arrangement for equalizing binocular fields of view as claimed in claim 19, wherein the adjusters comprise adjusting screws that can optionally be used in combination with a spring element as another adjuster.

21. The arrangement for equalizing binocular fields of view as claimed in claim 19, wherein two adjusters are arranged at an angular offset of 180 degrees.

22. The arrangement for equalizing binocular fields of view as claimed in claim 19, wherein three adjusters are arranged at angular offsets of 120 degrees.

23. The arrangement for equalizing binocular fields of view as claimed in claim 20, wherein two adjusters are arranged at an angular offset of 180 degrees.

24. The arrangement for equalizing binocular fields of view as claimed in wherein three adjusters are arranged at angular offsets of 120 degrees.
